(19) United States
(12) Patent Application Publication
(10) Pub. No.: US 2025/0334382 A1
(43) Pub. Date: Oct. 30, 2025

(54) FORM FACTOR MULTIFUNCTION PERSONAL SECURITY DEVICE

(71) Applicant: Ivan K. Smith, Lakin, KS (US)

(72) Inventor: Ivan K. Smith, Lakin, KS (US)

(21) Appl. No.: 19/188,496

(22) Filed: Apr. 24, 2025

Related U.S. Application Data
(60) Provisional application No. 63/637,974, filed on Apr. 24, 2024.

(51) Int. Cl. F41H 13/00; H04R 1/02; H04R 1/32

(52) U.S. Cl. CPC F41H 13/0018; H04R 1/028; H04R 1/323; F41H 13/0056

(57) ABSTRACT

A multi-function personal security device includes a body with an internal enclosure. Sound and light deterrent components are mounted on the body and configured for providing sound and light output. A stun gun is so mounted on the body and includes contacts. A trigger assembly is provided for actuating the deterrent components and the stun gun.

### CROSS-REFERENCE TO RELATED APPLICATION

This application claims priority in U.S. Provisional Patent Application Ser. No. 63/637,974, filed Apr. 24, 2024, which is incorporated herein by reference.

### BACKGROUND OF THE INVENTION

### 1. Field of the Invention

The present invention relates generally to personal security devices, and more specifically to a personal energy weapon (PEW) uniquely combining stun gun protection with sound and light generation.

### 2. Description of the Related Art

Personal security devices include audible alarms and transmitters for defensively summoning assistance. Offensive personal security devices include various weapons, which are capable of delivering lethal and non-lethal force. Non-lethal security devices include stun guns and other weaponry capable of temporarily disabling or deterring attackers.

Heretofore there has not been available a system or method for personal security with the advantages and features of the present invention.

### BRIEF SUMMARY OF THE INVENTION

The present invention generally provides a personal security device combining a stun gun with components generating audible alarms and flashing lights. The device can be configured in the shape of a handgun, with a two-function trigger for activating light and sound deterrence in a first stage, and a stun gun in a second stage. The personal security device can also be configured as a stand-alone attachment for a stun gun or firearm, such as a handgun.

### BRIEF DESCRIPTION OF THE DRAWINGS

The drawings constitute a part of this specification and include exemplary embodiments of the present invention illustrating various objects and features thereof.

FIG. 1 shows a form factor, multi-function personal security device embodying an aspect or embodiment of the present invention and configured as a handgun.

FIG. 2 is a schematic diagram thereof.

FIG. 3 is a side elevational view of a stand-alone personal security device comprising a modified or alternative embodiment of the present invention and configured for mounting on a stun gun or a firearm, such as a handgun.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof.

### II. Preferred Embodiment

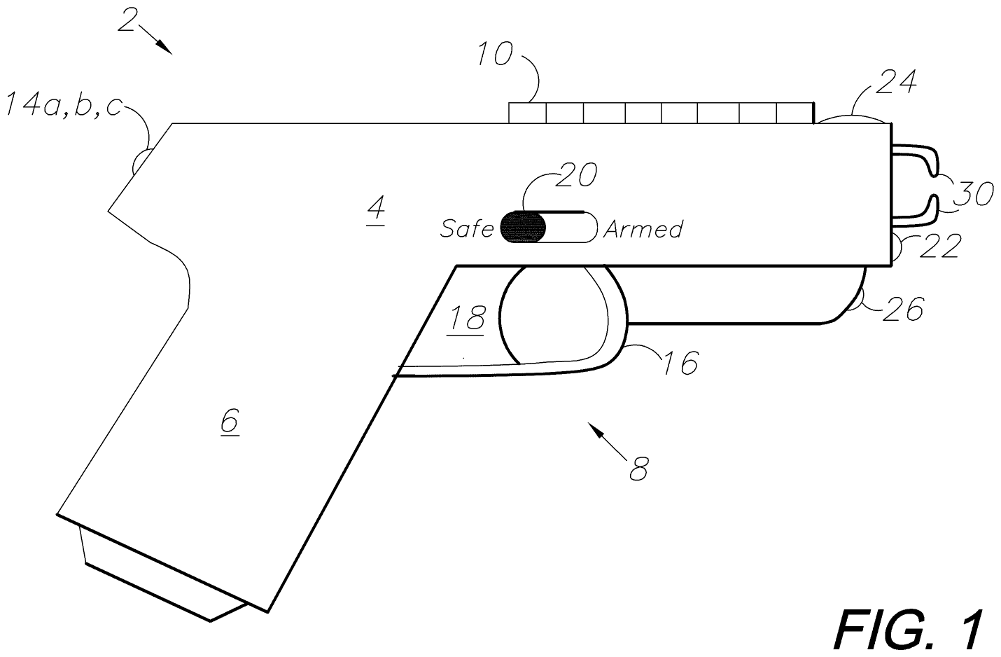

Referring to the drawings in more detail, FIG. 1 shows a form factor, multi-function, personal security device 2 comprising an aspect or embodiment of the present invention. Without limitation on the generality of possible configurations, the security device 2 is shown in a handgun configuration with a body 4, a handgrip 6 and a trigger assembly 8. The personal security device 2 utilizes an appropriate form factor for convenience, personal handling and quick access. For example, in a street attack situation, the Disruptor can be quickly employed to neutralize one or more attackers. Still further, it can be concealed and carried under clothing, in purses, holsters, etc.

An accessory rail 10 can be provided on top of the body 4 for attaching an accessory, such as a Bluetooth® camera, infrared optics, etc.

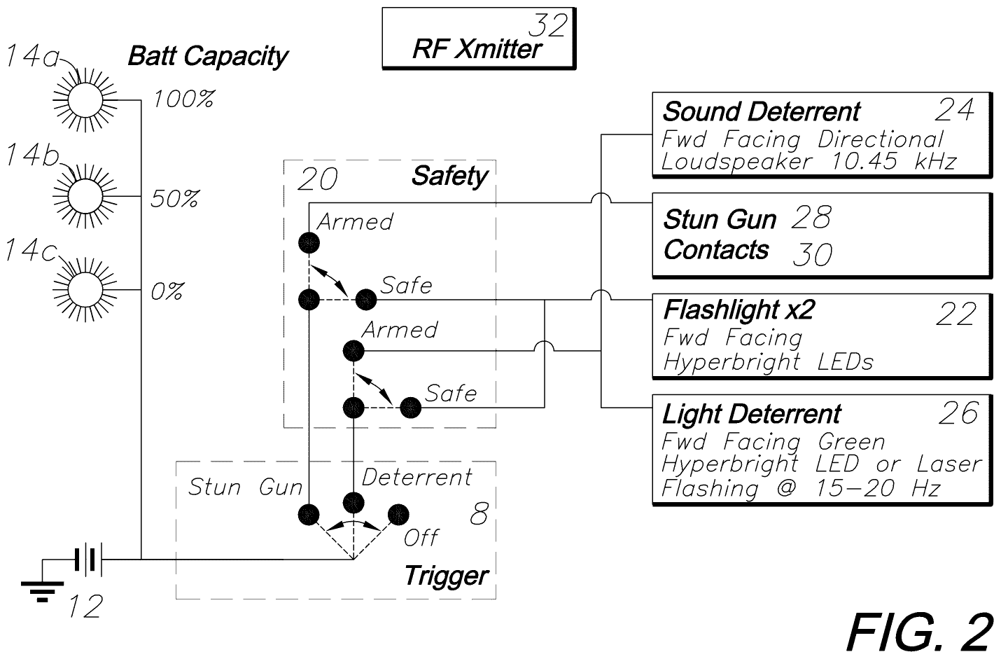

FIG. 2 is a schematic diagram of the personal security device 2, which is powered by a battery 12, which can be rechargeable. A user can carry one or more extra, charged batteries for extended operation. Battery capacity indicator lights 14a,b,c are mounted on the rear of the body 4 for visibility to a user. For example, a green indicator light 14a can indicate 100% charge, a yellow indicator light 14b can indicate 50% charge and a red indicator light 14c can indicate 0% charge. The trigger assembly 8 includes a trigger guard 16 depending downwardly from the body 4 and extending forwardly from the handgrip 6. A trigger 18 has three positions: off; half-pull; and full-pull. Personal security device 2 function in the trigger positions depends on whether a security device safety switch 20 is on (safe) or off (armed).

The following Table 1 shows the operation of the personal security device 2 in “safe” and “armed” modes:

TABLE 1

| Mode | Trigger Half-Pull | Trigger Full-Pull |
|---|---|---|
| Safe | Flashlight 22 | Flashlight 22 |
| Armed | Sound Deterrent 24 | Stun Gun 28 |
| | Light Deterrent 26 | |

The personal security device 2 outputs include:
1. The battery capacitor indicator lights 14a, 14b and 14c;
2. A pair of forward-facing hyper bright LEDs 22;
3. A sound deterrent 24 comprising a forward-facing directional loudspeaker. Without limitation, the output frequency can be in the range of approximately 10.35-10.55 kHz.
4. A light deterrent 26 comprising a forward-facing green hyper bright LED or laser flashing at 12-23 Hz.
5. A stun gun 28, including stun gun contacts 30 projecting forwardly from the body 4.
6. A radio frequency (RF) transmitter 32 configured for alerting others, such as first responders, when the sound-light deterrents 24, 26 and the stun gun 28 are deployed.

In operation, the preferred embodiment personal security device 2 discharges energy for stunning and disorienting an attacker similar to a stun gun. In an alternative embodiment taser mode, a painful deterrent force could be delivered from a distance. Additionally, the personal security device 2 generates an audible alarm, which both causes discomfort in an attacker and can summon assistance and/or cause an attacker to flee. Still further, a lighting function can be included to temporarily disorient an attacker and visually alert others.

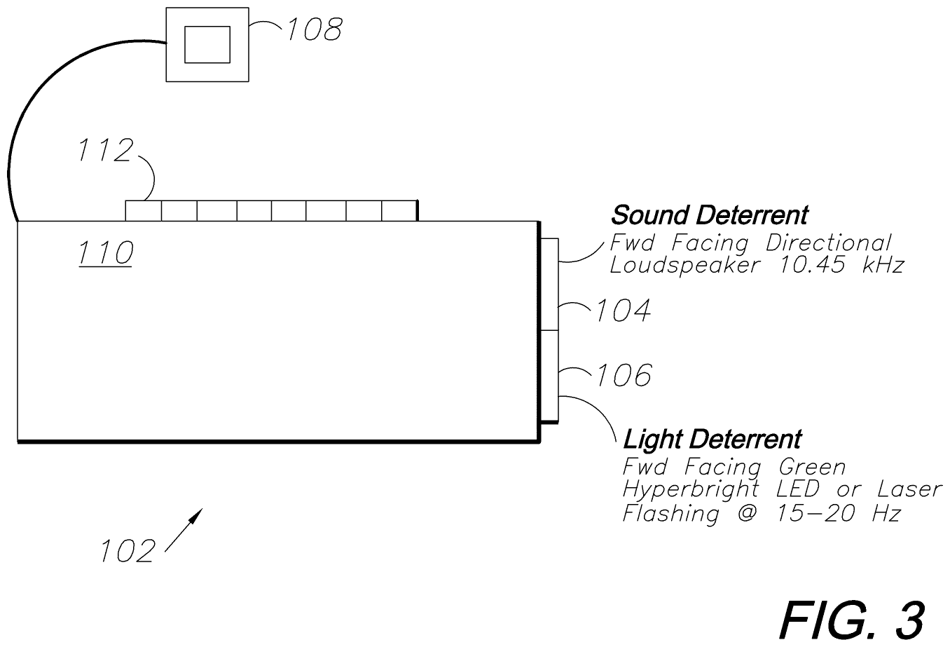

FIG. 3 shows a stand-alone personal security device 102 comprising a modified or alternative embodiment of the present invention with a bidirectional sound deterrent subsystem 104 and a light deterrent subsystem 106, which are actuated by an activation switch 108. The alternative embodiment personal security device 102 can include a housing 110 for enclosing the electrical components. A tactical rail mount 112 on the housing 110 enables mounting the stand-alone personal security device 102 on a stun gun, a firearm, etc.

In operation, the stand-alone personal security device 102 can function similarly to the corresponding components of the personal security device 2. Moreover, the form factor enables scaling to accommodate concealment, output power, range, power consumption and other operational parameters.

It is to be understood that while certain embodiments and/or aspects of the invention have been shown and described, the invention is not limited c thereto and encompasses various other embodiments and aspects.

1. A multi-function, personal security device, which comprises:
a body with an internal enclosure;
an activation switch connected to said body;
a sound deterrent component mounted on said body and connected to said activation switch; and
a light deterrent component mounted on said body and connected to said activation switch.

2. The personal security device according to claim one, which includes:
said body configured as a handgun; and
said activation switch configured as a trigger of said handgun configuration body; and
a stun gun mounted on said body and connected to said activation switch.

3. The personal security device according to claim 1, which includes a trigger assembly including said activation switch and configured for selectively activating said sound and light deterrent components and said stun gun.

4. The personal security device according to claim 1, which includes a flashlight activated by said activation switch.

5. The personal security device according to claim 1, wherein said enclosure comprises a housing with said activation switch connected thereto.

6. The personal security device according to claim 5, which includes:
A tactical rail mount mounted on said housing and configured for attaching said personal security device to a weapon, comprising a handgun or a taser.

7. A multi-function, personal security device, which comprises:
a body with an internal enclosure;
said body configured as a handgun with a front muzzle end, a back end, a handgrip and a trigger assembly connected to said handgrip;
a battery mounted within said body;
multiple battery charge capacity indicator lights mounted on said body back end and configured for illumination to indicate full charge, partial charge and no charge conditions of said battery;
an accessory rail mounted on said body and extending upwardly therefrom in proximity to said muzzle end;
said accessory rail being configured to mount a camera on said body;
said trigger assembly including a trigger guard connected to and extending forwardly from said handgrip;
said trigger assembly including a trigger partially enclosed by said trigger guard;
a single pole, double throw (SPDT) trigger switch connected to said battery and having: an off position; half-pull deterrent position; and a full-pull stun position;
said trigger operating said trigger switch;
a safety switch mounted on said body and comprising a double pole, single throw (DPST) switch with safe and armed positions;
a forward-facing flashlight mounted on said body front muzzle end;
a sound deterrent including a forward-facing, directional loudspeaker mounted on said body in proximity to said front muzzle end;
a light deterrent mounted on said body front muzzle end and comprising one of a hyper bright LED or a laser;
said light deterrent configured for flashing when activated;
said safety switch in its safe position, enabling actuation of said flashlight when said trigger is pulled;
said safety switch in its safe position disabling operation of said sound and light deterrents;
a stun gun mounted on said body front muzzle end and including a pair of stun gun contacts protruding from said body front muzzle end;
said safety switch in its armed position enabling operation of said sound and light deterrents and said stun gun; and
said trigger switch actuating said sound and light deterrents in its half-pull position and energizing said stun gun contacts in its full-pull position.
